(19) United States
(12) Patent Application Publication
(10) Pub. No.: US 2025/0369748 A1
(43) Pub. Date: Dec. 4, 2025

(54) METHOD FOR MEASURING FILM THICKNESS IN SITU, REFERENCE SPECTRUM GENERATION METHOD, AND DEVICES

(71) Applicant: BEIJING TSD SEMICONDUCTOR CO., LTD., Beijing (CN)

(72) Inventors: Weitao MENG, Beijing (CN); Huiyan ZHOU, Beijing (CN); Jile JIANG, Beijing (CN)

(73) Assignee: BEIJING TSD SEMICONDUCTOR CO., LTD., Beijing (CN)

(21) Appl. No.: 19/063,657

(22) Filed: Feb. 26, 2025

Related U.S. Application Data
(63) Continuation of application No. PCT/CN2024/135882, filed on Nov. 29, 2024.

(30) Foreign Application Priority Data
May 29, 2024 (CN) 202410682207.5
May 29, 2024 (CN) 202410682419.3

(51) Int. Cl. G01B 11/06

(52) U.S. Cl. CPC G01B 11/0625

(57) ABSTRACT

The present invention provides a method for measuring a film thickness in situ, a reference spectrum generation method, and devices, and the method includes: obtaining a spectrum computation model having a first layer and a second layer, where the second layer is located between the first layer and a wafer film; determining spectrum parameters of the first layer, the second layer, the wafer film, and a wafer substrate; and computing, based on the spectrum parameters and the spectrum computation model, reference spectra under different given thicknesses of the wafer film.

### CROSS-REFERENCE TO RELATED APPLICATIONS

The application claims priority to Chinese patent application No. 202410682419.3, filed on May 29, 2024 and Chinese patent application No. 202410682207.5, filed on May 29, 2024, the entire contents of which are incorporated herein by reference.

### TECHNICAL FIELD

The present invention relates to the field of wafer parameter measurement, and in particular, to a method for measuring a film thickness in situ, a reference spectrum generation method, and devices.

### BACKGROUND

In wafer manufacturing, with the upgrade of manufacturing technology and the reduction of wire and the gate sizes, lithography technology has increasingly higher requirements for the non-uniformity of a wafer surface, while the chemical mechanical polish (CMP) technology has been widely applied to the wafer in recent decades. The CMP has a very high requirement for precision of polishing, and precise thickness measurement needs to be performed on a wafer film for matching precision requirements. Due to the complexity of the CMP processing environment, in the prior art, optical non-contact in-situ real-time measurement cannot be realized on the wafer films, and the wafer can only be removed from the CMP for off-line measurement and other endpoint measurement, while the endpoint measurement can only detect a grinding endpoint, but cannot perform real-time measurement.

When implementing embodiments of the present invention, the inventor found that in the optical non-contact in-situ real-time measurement of a wafer film, various dielectrics exist between the wafer and the probe, such as glass, PU, and slurry. Under the influence of these dielectrics, a “deformation” phenomenon will occur in a reflectance spectrum, however, the theoretical spectrum of a to-be-measured film (wafer film) in the prior art cannot accurately describe the “deformation” phenomenon, resulting in that the exact thickness of the to-be-measured film cannot be accurately measured in the prior art, further resulting in that since the CMP is applied to the semiconductor manufacturing and processing industry, the in-situ measurement of the thickness of the wafer film in a processing process has not been realized.

### SUMMARY

In view of the foregoing, the present application provides a reference spectrum generation method for measuring a film thickness in situ, including the following steps:
acquiring a spectrum computation model having parameters of a first layer and a second layer, where the second layer is located between the first layer and a wafer film;
determining spectrum parameters of the first layer, the second layer, the wafer film, and a wafer substrate; and
computing, based on the spectrum parameters and the spectrum computation model, reference spectra under different given thicknesses of the wafer film.

Optionally, determining the spectrum parameter of the second layer includes:
acquiring a measured spectrum of a surface of a wafer in a state of a first layer and a second layer, where the wafer includes a wafer substrate and a wafer film, and parameters of the wafer substrate and the wafer film are known parameters measured in advance;
generating, based on the spectrum computation model, theoretical spectra under different given spectrum parameters of the second layer; and
determining the spectrum parameter of the second layer based on the theoretical spectra and the measured spectrum.

Optionally, the step of determining the spectrum parameter of the second layer based on the theoretical spectra and the measured spectrum includes:
matching a plurality of theoretical spectra with the measured spectrum, and screening out a theoretical spectrum of which a matching degree is higher than a threshold; and
determining the spectrum parameter of the second layer based on the theoretical spectrum of which the matching degree is higher than the threshold.

Optionally, the reference spectrum includes a curve of a correspondence between of a wavelength and a reflectance.

Optionally, the spectrum parameters include a refractive index n₁ of the first layer, a refractive index n₂ of the wafer film, a refractive index n₃ of the wafer substrate, a refractive index n₄ of the second layer, and a thickness d₄ of the second layer.

Optionally, the spectrum computation model includes:

$$R = r \cdot {r}^{*}$$

where r represents a total reflection coefficient determined based on n₁, n₂, n₃, n₄, and d₄, r* represents a conjugate complex number of r, and R represents a reflectance.

Optionally, the total reflection coefficient r is computed in the following manner:
computing, based on n₁, n₂, n₃, and n₄, reflection coefficients of an interface of each layer;
computing, based on n₂, a wavelength λ, and a thickness d₂ of the wafer film, a phase thickness θ of the wafer film;
computing, based on n₄, the wavelength Δ, and the thickness d₄, a phase thickness α of the second layer; and
computing, based on the reflection coefficients of an interface of each layer, the phase thickness α, and the phase thickness θ, the total reflection coefficient r.

Optionally, the reflection coefficients of an interface of each layer include a reflection coefficient r₂ of an interface between the wafer film and the wafer substrate, a reflection coefficient r₃ of an interface between the first layer and the second layer, and a reflection coefficient r₄ of an interface between the second layer and the wafer film.

Optionally, the step of computing the reflection coefficients of an interface of each layer includes:
computing, based on n₂ and n₃, the reflection coefficient r₂ of the interface between the wafer film and the wafer substrate;
computing, based on n₁ and n₄, the reflection coefficient r₃ of the interface between the first layer and the second layer; and
computing, based on n₂ and n₄, the reflection coefficient r₄ of the interface between the second layer and the wafer film.

Optionally, the step of computing the total reflection coefficient r includes:
computing, based on θ, r₂, and r₄, an equivalent interface reflection coefficient r_{equivalent}; and
computing, based on α, r₃, and r_{equivalent}, the total reflection coefficient r.

The present application further provides a method for measuring a film thickness in situ, including:
acquiring a measured spectrum during a grinding process of the wafer film;
matching the measured spectrum with a reference spectrum library obtained based on the above method; and
acquiring a wafer film thickness corresponding to a reference spectrum matched with the measured spectrum as a real-time detection result.

The present application further provides an endpoint detection method for wafer film grinding, including the following steps:
monitoring, based on the above method for measuring a film thickness in situ, whether a thickness of a wafer film reaches a target thickness in real time; and
stopping grinding when the thickness of the wafer film reaches the target thickness.

Accordingly, the present application further provides an electronic device, including: a processor and a memory connected to the processor, where the memory stores instructions that can be executed by the processor, and the instructions are executed by the processor, so that the processor performs the above method.

According to the reference spectrum generation method, and devices provided in the present application, spectrum parameters of two near-surface layers are introduced into a spectrum model, and thus the computed spectra under different given thicknesses of the wafer film reflect a phenomenon of deformation, which is consistent with a situation that the measured spectrum appears. The reference spectrum library generated by this solution is used for measuring the thickness of the wafer film, which may improve accuracy. According to actual requirements, the reference spectrum generated by this solution may be used for measuring the thickness of the wafer film in situ and in real time in a CMP environment, thereby greatly improving the efficiency and precision of semiconductor manufacturing and processing.

The present application provides another reference spectrum generation method for measuring a film thickness in situ, including the following steps:
acquiring a spectrum computation model, where the spectrum computation model includes parameters of a surface equivalent layer and a wafer, and the surface equivalent layer is at least used for simulating a layer formed by a substance between bulk phase water on a surface of a wafer film and the surface of the wafer film;
determining spectrum parameters of the surface equivalent layer, a wafer film, and a wafer substrate; and
computing, based on the spectrum parameters and the spectrum computation model, reference spectra under different given thicknesses of the wafer film.

Optionally, the step of determining the spectrum parameter of the surface equivalent layer includes:
acquiring a measured spectrum of a surface of a wafer in a state of a surface equivalent layer, where the wafer includes a wafer substrate and a wafer film, and parameters of the wafer substrate and the wafer film are known parameters measured in advance;
generating, based on the spectrum computation model, theoretical spectra under different given spectrum parameters of the surface equivalent layer; and
determining the spectrum parameter of the surface equivalent layer based on the theoretical spectra and the measured spectrum.

Optionally, the step of determining the spectrum parameter of the surface equivalent layer based on the theoretical spectra and the measured spectrum includes:
matching a plurality of theoretical spectra with the measured spectrum, and screening out a theoretical spectrum of which a matching degree is higher than a threshold; and
determining the spectrum parameter of the surface equivalent layer based on the theoretical spectrum of which the matching degree is higher than the threshold.

Optionally, the reference spectrum includes a curve of a correspondence between of a wavelength and a reflectance.

Optionally, the spectrum parameters include a refractive index n₁ of the surface equivalent layer, a refractive index n₂ of the wafer film, and a refractive index n₃ of the wafer substrate.

Optionally, the spectrum computation model includes:

$$R = r \cdot {r}^{*}$$

where r represents a total reflection coefficient determined based on n₁, n₂, and n₃, r* represents a conjugate complex number of r, and R represents a reflectance.

Optionally, the total reflection coefficient r is computed in the following manner:
computing, based on n₁, n₂, and n₃, reflection coefficients of an interface of each layer;
computing, based on n₂, a wavelength λ, and a thickness d₂, a phase thickness θ of the wafer film; and
computing, based on the reflection coefficients of an interface of each layer and the phase thickness θ, the total reflection coefficient r.

Optionally, the reflection coefficients of an interface of each layer include a reflection coefficient r₁ of an interface between the surface equivalent layer and the wafer film, and a reflection coefficient r₂ of an interface between the wafer film and the wafer substrate.

Optionally, the step of computing the reflection coefficients of an interface of each layer includes:
computing, based on n₁ and n₂, the reflection coefficient ry of the interface between the surface equivalent layer and the wafer film; and
computing, based on n₂ and n₃, the reflection coefficient r₂ of the interface between the wafer film and the wafer substrate.

Optionally, the surface equivalent layer is further used for simulating the bulk phase water on the surface of the wafer film, and a layer formed by a variety of dielectrics between the bulk phase water and a spectrum collection end.

The present application further provides another method for measuring a film thickness in situ, including the following steps:
acquiring a measured spectrum during a grinding process of the wafer film;
matching the measured spectrum with a reference spectrum library obtained based on the above method; and
acquiring a wafer film thickness corresponding to a reference spectrum matched with the measured spectrum as a real-time detection result.

The present application further provides another endpoint detection method for wafer film grinding, including the following steps:
monitoring, based on the above method for measuring a film thickness in situ, whether a thickness of a wafer film reaches a target thickness in real time; and
stopping grinding when the thickness of the wafer film reaches the target thickness.

Accordingly, the present application provides an electronic device, including: a processor and a memory connected to the processor, where the memory stores instructions that can be executed by the processor, and the instructions are executed by the processor, so that the processor performs the above method.

According to the reference spectrum generation method provided in the present application, a surface equivalent layer structure and a parameter of the layer are introduced into a spectrum model, and a dielectric between a wafer film and a spectrum measurement end in a grinding scenario is simulated through the surface equivalent layer, and thus the computed spectra under different given thicknesses of the wafer film reflect a phenomenon of deformation, which is consistent with a situation that the measured spectrum appears. The reference spectrum library generated by this solution is used for measuring the thickness of the wafer film, which may improve accuracy.

### BRIEF DESCRIPTION OF THE DRAWINGS

To describe the technical solutions in the specific embodiments of the present invention or in the prior art more clearly, the following briefly describes the accompanying drawings needed for describing the specific embodiments or the prior art. Apparently, the accompanying drawings in the following description show some embodiments of the present invention, and those of ordinary skill in the art may further derive other accompanying drawings from these accompanying drawings without creative labor.

FIG. 1 is a schematic diagram of a scenario of measuring a film thickness in situ according to an embodiment of the present invention;

FIG. 2 is a comparison diagram of a reference spectrum and a measured spectrum according to an embodiment of the present invention;

FIG. 3 is a plurality reference spectrum curves according to an embodiment of the present invention; and

FIG. 4 is a comparison chart between theoretical spectral curve and a measured spectrum curve according to an embodiment of the present invention.

### DETAILED DESCRIPTION OF THE EMBODIMENTS

An explicit and complete description of the technical solutions in the present invention is given below in conjunction with the accompanying drawings. Apparently, the described embodiments are part not all of the embodiments of the present invention. Based on the embodiments in the present invention, all other embodiments obtained by those of ordinary skill in the art without making creative labor fall within the scope of protection of the present invention.

In addition, the technical features involved in different embodiments of the present invention described below may be combined with each other as long as they do not conflict with each other.

An embodiment of the present invention provides a reference spectrum generation method for measuring a film thickness in situ. The method can be performed by an electronic device such as a computer or a server, and includes the following operation steps:

a spectrum computation model is acquired, where the spectrum computation model includes parameters of a surface equivalent layer and a wafer, and the surface equivalent layer is at least used for simulating a layer formed by a substance between bulk phase water on a surface of a wafer film and the surface of the wafer film.

Spectrum parameters of the surface equivalent layer, a wafer film, and a wafer substrate are determined. The spectrum parameter of the surface equivalent layer may be computed in a theoretical computation manner. The spectrum parameters of the wafer film and the wafer substrate are generally known, or may be obtained by measurement. Reference spectra under different given thicknesses of the wafer film are computed based on the spectrum parameters and the spectrum computation model. The reference spectrum may be corresponding relationship data of a wavelength and a reflectance, and may be expressed by a curve, that is, the reference spectrum may be a curve of a correspondence between of a wavelength and a reflectance. In this embodiment, a technology in the art may deform a corresponding relation between the wavelength and the reflectance according to actual needs, and for a person of ordinary skill in the art, other changes or modifications in different forms may be made on the basis of the above description. All implementations need not be and cannot be exhaustive herein. Obvious changes or modifications derived therefrom are still within the protection scope of the present invention.

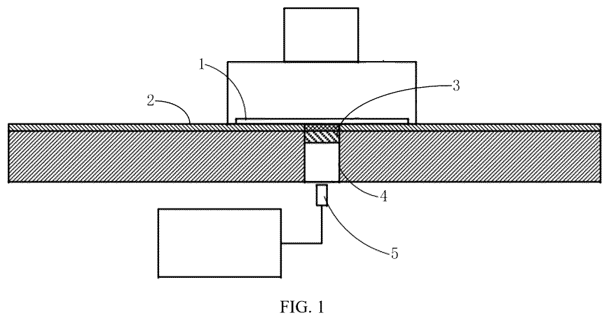

As shown in FIG. 1, a final measurement object in the application scenario faced by the embodiment of the present invention is a wafer 1. The wafer 1 includes a wafer substrate and a wafer film. The wafer 1 is placed in a to-be-ground or grinding state, there is bulk phase water between a grinding surface of the wafer film and a polishing pad 2, and may specifically be a slurry, water, or the like, and a substance exists between the bulk phase water and the wafer film. In the orientation shown in FIG. 1, the bulk phase water is located between the lower surface of the wafer 1 and the polishing pad 2, the so-called substance is located between the bulk phase water and a lower surface of the wafer 1, and these substances may be a substance, such as air or may be a variety of substances.

The substance between the bulk phase water and the wafer film has an influence on the spectrum of the reflected light of the wafer film. In order to avoid this influence, in one embodiment, a surface equivalent layer is arranged to simulate a layer formed by a substance between the wafer film and the bulk phase water, and a related parameter of the surface equivalent layer is introduced when a spectrum computation model is constructed.

There are also a variety of dielectrics between the bulk phase water and the spectrum collection end, and in the orientation shown in FIG. 1, there are one or more sealing layers 3 and air layers 4 below the bulk phase water, and the reflected light on the surface of the wafer film of the wafer 1 passes through the variety of dielectrics to enter the spectrum collection end 5, and all of these dielectrics have an influence on the spectrum. In order to avoid the influence of the dielectric between the bulk phase water and the wafer film and the dielectric between the bulk phase water and the spectrum collection end on the spectrum, in one embodiment, a surface equivalent layer is arranged to simulate a variety of dielectric layers between the wafer film and the spectrum collection end, and a related parameter of the surface equivalent layer is introduced when a spectrum computation model is constructed.

It should be noted that, because the surface equivalent layer simulates at least two different dielectrics, a value of a related parameter thereof is different from a parameter value of each dielectric that is simulated, and should be equivalent a common function of the variety of dielectrics.

As an example, it is assumed that the surface of the wafer film in the measurement scenario is a slurry, and an air layer is included between the slurry and the wafer film. A parameter of the surface equivalent layer in this embodiment may specifically include a refractive index, and the refractive index is neither equal to a refractive index of the slurry nor equal to a refractive index of air.

The spectrum computation model is specifically a set of computation formulas, and a reflectance corresponding to the spectrum parameter can be computed by substituting a value of the spectrum parameter into the computation formula. Specifically, the spectrum computation model may be expressed in the following manner: f(x)=R, where x represents a spectrum parameter and R represents a reflectance. The spectrum parameter includes at least a wavelength λ and a thickness d₂ of the wafer film, and in this embodiment, a parameter of the surface equivalent layer is further included.

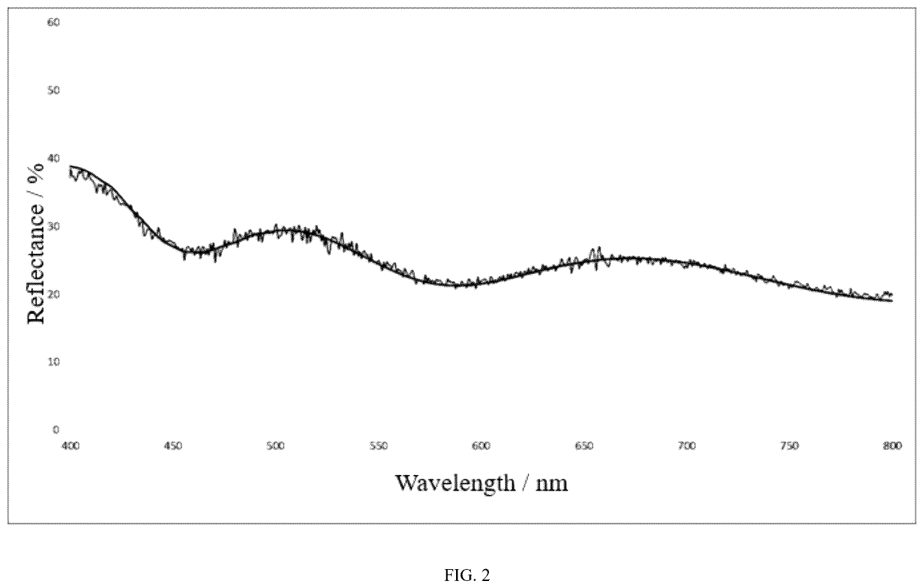

Each reference spectrum corresponds to a different d₂, such as curves shown in FIG. 2, where a relatively smooth curve is a curve of the reference spectrum, which is a fitted curve computed by the method, and corresponds to a reflectance whose a value of d₂ is 700 nm and a reflectance whose a value range of the wavelength λ is 400-800 nm. The method computes a reflectance R corresponding to a given wavelength λ range for different given d₂, thereby obtaining reference spectra corresponding to different d₂.

With regard to the spectrum parameters, in one embodiment, a refractive index n₁ of the surface equivalent layer, a refractive index n₂ of the wafer film, and a refractive index n₃ of the wafer substrate are specifically included.

As an example, the spectrum computation model may specifically be:

$$R = r \cdot {r}^{*}$$

where r represents a total reflection coefficient determined based on n₁, n₂, and n₃, r* represents a conjugate complex number of r, and R represents a reflectance.

In an embodiment, the total reflection coefficient r is computed in the following manner:

computing, based on n₁, n₂, and n₃, reflection coefficients of an interface of each layer; computing, based on n₂, a wavelength λ, and a thickness d₂, a phase thickness θ of the wafer film; and computing, based on the reflection coefficients of an interface of each layer and the phase thickness θ, the total reflection coefficient r.

Further, the reflection coefficients of an interface of each layer include a reflection coefficient r₁ of an interface between the surface equivalent layer and the wafer film, and a reflection coefficient r₂ of an interface between the wafer film and the wafer substrate.

Computing the reflection coefficients of an interface of each layer includes: computing r₁ based on n₁ and n₂, and computing r₂ based on n₂ and n₃.

As an example, the r may be computed as follows:

$$r = \frac{{r}_{1} + {r}_{2} \cdot {e}^{i \cdot 2 θ}}{1 + {r}_{1} \cdot {r}_{2} \cdot {e}^{i \cdot 2 θ}}$$

where i represents an imaginary unit and e represents a natural constant.

Further, the r₁ and r₂ are computed in the following manner:

$$\begin{matrix}{r}_{1} = \frac{{n}_{1} - {n}_{2}}{{n}_{1} + {n}_{2}} \\ {r}_{2} = \frac{{n}_{2} - {n}_{3}}{{n}_{2} + {n}_{3}}\end{matrix}$$

Further, the θ is computed in the following manner:

$$θ = \frac{4 π {n}_{2} {d}_{2}}{λ}$$

With regard to the above computation formulas, simple deformation may also be performed according to actual needs, for example, a preset coefficient or a weight is added to a certain computation formula. For a person of ordinary skill in the art, other changes or modifications in different forms may be made on the basis of the above description. All computation formulas need not be and cannot be exhaustive herein. Obvious changes or modifications derived therefrom are still within the protection scope of the present invention.

The reference spectrum computed in this embodiment is used for comparison with a measured spectrum of a wafer in an online state (grinding state or to-be-ground state), and a set of reference spectra for these different wafer film thicknesses is referred to as a reference spectrum library.

According to the reference spectrum generation method provided in the embodiment of the present invention, a surface equivalent layer structure and a parameter of the layer are introduced into a spectrum model, and a dielectric between a wafer film and a spectrum measurement end in a grinding scenario is simulated through the surface equivalent layer, and thus the computed spectra under different given thicknesses of the wafer film reflect a phenomenon of deformation, which is consistent with a situation that the measured spectrum appears. The reference spectrum library generated by this solution is used for measuring the thickness of the wafer film, which may improve accuracy.

With regard to the spectrum parameter of the surface equivalent layer, in an embodiment, a method for determining the spectrum parameter of the surface equivalent layer is provided, including:

a measured spectrum of a surface of a wafer in a state of a surface equivalent layer is acquired, where the wafer includes a wafer substrate and a wafer film, and parameters of the wafer substrate and the wafer film are known parameters measured in advance; and

theoretical spectra under different given spectrum parameters of the surface equivalent layer are generated based on the spectrum computation model. For a generation manner of the spectrum computation model and the theoretical spectrum, reference may be made to the above embodiments with respect to the reference spectrum. The difference from the process of generating the reference spectrum is that the spectrum parameters of the wafer film and the wafer substrate are fixed values, and the spectrum parameters of the surface equivalent layer are a plurality of given values.

Specifically, the parameters involved in the spectrum computation model include the refractive index n₁ of the surface equivalent layer, the refractive index n₂ of the wafer film, and the refractive index n₃ of the wafer substrate, where n₂ and n₃ are known, and in this embodiment, a plurality of n₁ are given, which are denoted as [n₁ᵢ, n₁ⱼ].

In this embodiment, the thickness d₂ of the wafer film is a known fixed value, and a plurality of theoretical spectra corresponding to [n₁ᵢ, n₁ⱼ] are computed based on the spectrum computation model.

The spectrum parameter of the surface equivalent layer is determined based on the theoretical spectra and the measured spectrum. Specifically, the plurality of theoretical spectra may be matched with the measured spectrum, and a part of the theoretical spectra of which a matching degree is higher than the threshold is screened out, and a corresponding refractive index is denoted as [n₁ⱼ, n₁ₖ]; and if a sufficiently high threshold is set, a theoretical spectrum matching the measured spectrum may also be obtained, and a corresponding refractive index is denoted as nip.

Therefore, a value may be selected from [n₁ⱼ, n₁ₖ] as the spectrum parameter of the surface equivalent layer, or nip is used as the spectrum parameter of the surface equivalent layer.

In this embodiment, the theoretical spectrum is generated based on the given spectrum parameters of the plurality of surface equivalent layers, and a value of the spectrum parameter of the surface equivalent layer is determined by matching with the measured spectrum, so that the accuracy is relatively high.

This embodiment further provides a method for measuring a film thickness in situ. Online detection is performed based on reference spectra (reference spectrum library) of different given thicknesses of the wafer film obtained by the above method. The method needs to be performed by an electronic device such as a computer or a server, and includes the following operation steps:

a measured spectrum is acquired during a grinding process of the wafer film. There is bulk phase water on the surface of the wafer film during the grinding process, and there is at least another dielectric between the bulk phase water and the collection end of the measured spectrum.

The measured spectrum is matched with a reference spectrum library. One reference spectrum that is most similar to the measured spectrum is determined by comparing all the reference spectra with the measured spectrum one by one. There are a variety of methods for computing the similarity between two the spectra, and there are a variety of indexes for measuring the similarity or matching degree, for example, a similarity method, a nonlinear regression method, an FFT method, and the like.

A wafer film thickness corresponding to a reference spectrum matched with the measured spectrum is acquired as a real-time detection result. The curve with obvious fluctuation of ordinate in FIG. 2 is the curve of the measured spectrum. It is assumed that a similarity between the measured spectrum and the reference spectrum in FIG. 2 is determined to be the highest, and since a thickness corresponding to the reference spectrum is 700 nm, a real-time monitoring result is that a thickness of a wafer film is 700 nm.

This embodiment further provides an endpoint detection method for wafer film grinding. The grinding is controlled in real time based on the above online detection method. The method needs to be performed by an electronic device such as a computer or a server, and includes the following operation steps:

during a wafer grinding process, whether a thickness of a wafer film reaches a target thickness is monitored in real time based on the above method for measuring a film thickness in situ; and when the thickness of the wafer film reaches the target thickness, the grinding is stopped.

An embodiment of the present invention provides another reference spectrum generation method for measuring a film thickness in situ. The method can be performed by an electronic device such as a computer or a server, and includes the following operation steps:

a spectrum computation model having parameters of a first layer and a second layer is acquired, where the second layer is located between the first layer and a wafer film. A final measurement object in the application scenario faced by the embodiment of the present invention is a wafer. The wafer includes a wafer substrate and a wafer film. The wafer is placed in a to-be-ground or grinding state, the grinding surface of the wafer film is covered with the bulk phase water, and may specifically be a slurry, water, or the like. There are a variety of dielectrics between the bulk phase water and the wafer film, the plurality of dielectrics are located between the bulk phase water and the wafer film, a dielectric in direct contact with the bulk phase water is generally air (forming the first layer), and there is another dielectric (forming the second layer) between the air layer and the wafer film.

The first layer and second layer have an influence on the spectrum of the reflected light of the wafer film. In order to avoid the influence of the dielectric between the bulk phase water and the wafer film on the spectrum, in this embodiment, two layers are arranged to simulate a layer formed by the variety of dielectrics between the wafer film and the bulk phase water, and a related parameter of the two layers is introduced when a spectrum computation model is constructed.

Spectrum parameters of the first layer, the second layer, the wafer film, and a wafer substrate are determined. The first layer may be regarded as a layer formed by air, and therefore, the spectrum parameter thereof may be valued according to the air. The spectrum parameter of the second layer may be computed in a theoretical computation manner, and the spectrum parameters of the wafer film and the wafer substrate are generally known, or may also be obtained by measurement.

Reference spectra under different given thicknesses of the wafer film are computed based on the spectrum parameters and the spectrum computation model. The reference spectrum may be corresponding relationship data of a wavelength and a reflectance, and may be expressed by a curve, that is, the reference spectrum may be a curve of a correspondence between of a wavelength and a reflectance. In this embodiment, a technology in the art may deform a corresponding relation between the wavelength and the reflectance according to actual needs, and for a person of ordinary skill in the art, other changes or modifications in different forms may be made on the basis of the above description. All implementations need not be and cannot be exhaustive herein. Obvious changes or modifications derived therefrom are still within the protection scope of the present invention.

The spectrum computation model is specifically a set of computation formulas, and a reflectance corresponding to the spectrum parameter can be computed by substituting a value of the spectrum parameter into the computation formula. Specifically, the spectrum computation model may be expressed in the following manner: f(x)=R, where x represents a spectrum parameter and R represents a reflectance. The spectrum parameter includes at least a wavelength λ and a thickness d₂ of the wafer film, and in this embodiment, spectrum parameters of the first layer and the second layer are further included.

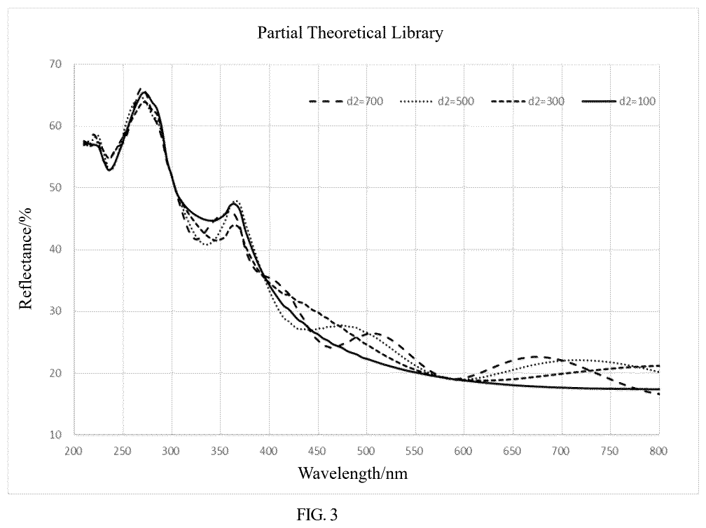

The thickness d₂ of the wafer film is a plurality of different given values, and the curves computed under different values of d₂ are different. The method computes the reflectance R corresponding to the given wavelength λ range for different given d₂, thereby obtaining reference spectra corresponding to different d₂. FIG. 3 shows curves of four spectra of d₂ of 100 nm, 300 nm, 500 nm, and 700 nm.

With regard to the spectrum parameters, in one embodiment, a refractive index n₁ of the first layer, a refractive index n₂ of the wafer film, a refractive index n₃ of the wafer substrate, a refractive index n₄ of the second layer, and a thickness d₄ of the second layer are specifically included.

As an example, the spectrum computation model may specifically be:

$$R = r \cdot {r}^{*}$$

where r represents a total reflection coefficient determined based on n₁, n₂, n₃, n₄, and d₄, r* represents a conjugate complex number of r, and R represents a reflectance. According to the above model, R corresponding to each A may be computed for each given d₂, thereby obtaining reference spectrum data.

In an embodiment, the total reflection coefficient r is computed in the following manner:

computing, based on n₁, n₂, n₃, and n₄, reflection coefficients of an interface of each layer; computing, based on n₂, a wavelength λ, and a thickness d₂ of the wafer film, a phase thickness θ of the wafer film; computing, based on n₄, a wavelength λ, and a thickness d₄, a phase thickness α of the second layer; and computing, based on the reflection coefficients of an interface of each layer and the phase thickness α, and the phase thickness θ, the total reflection coefficient r.

Further, the reflection coefficients of an interface of each layer include a reflection coefficient r₂ of an interface between the wafer film and the wafer substrate, a reflection coefficient r₃ of an interface between the first layer and the second layer, and a reflection coefficient r₄ of an interface between the second layer and the wafer film.

The step of computing the reflection coefficients of an interface of each layer includes: computing, based on n₂ and n₃, the reflection coefficient r₂ of the interface between the wafer film and the wafer substrate; computing, based on n₁ and n₄, the reflection coefficient r₃ of the interface between the first layer and the second layer; and computing, based on n₂ and n₄, the reflection coefficient r₄ of the interface between the second layer and the wafer film.

The step of computing the total reflection coefficient r includes: computing, based on θ, r₂, and r₄, an equivalent interface reflection coefficient r_{equivalent}; and computing, based on α, r₃, and r_{equivalent}, the total reflection coefficient r.

As an example, the reflection coefficient may be computed as follows:

$$\begin{matrix}{r}_{2} = \frac{{n}_{2} - {n}_{3}}{{n}_{2} + {n}_{3}} \\ {r}_{3} = \frac{{n}_{1} - {n}_{4}}{{n}_{1} + {n}_{4}} \\ {r}_{4} = \frac{{n}_{4} - {n}_{2}}{{n}_{4} + {n}_{2}}\end{matrix}$$

The phase thickness θ may be computed in the following manner:

$$θ = \frac{4 π {n}_{2} {d}_{2}}{λ}$$

The phase thickness α may be computed in the following manner:

$$α = \frac{4 π {n}_{4} {d}_{4}}{λ}$$

The equivalent interface reflection coefficient r_{equivalent} may be computed in the following manner:

$${r}_{e q u i v a l e n t} = \frac{{r}_{4} + {r}_{2} \cdot {e}^{i \cdot 2 θ}}{1 + {r}_{4} \cdot {r}_{2} \cdot {e}^{i \cdot 2 θ}}$$

The total reflection coefficient r may be computed in the following manner:

$$r = \frac{{r}_{3} + {r}_{equivalent} \cdot {e}^{i \cdot 2 α}}{1 + {r}_{3} \cdot {r}_{equivalent} \cdot {e}^{i \cdot 2 α}}$$

where i represents an imaginary unit and e represents a natural constant.

With regard to the above computation formulas, simple deformation may also be performed according to actual needs, for example, a preset coefficient or a weight is added to a certain computation formula. For a person of ordinary skill in the art, other changes or modifications in different forms may be made on the basis of the above description. All computation formulas need not be and cannot be exhaustive herein. Obvious changes or modifications derived therefrom are still within the protection scope of the present invention.

With regard to the spectrum parameter of the second layer, in an embodiment, a method for determining a spectrum parameter is provided to determine the value of the spectrum parameter, including the following operation steps:
a measured spectrum of a surface of a wafer in a state of a first layer and a second layer is acquired, where the wafer includes a wafer substrate and a wafer film, and parameters of the wafer substrate and the wafer film are known parameters measured in advance; and
theoretical spectra under different given spectrum parameters of the second layer are generated based on the spectrum computation model. The difference from the process of generating the reference spectrum is that the spectrum parameters of the wafer film and the wafer substrate are fixed values, and the spectrum parameters of the second layer are a plurality of given values.

The spectrum parameter of the second layer is determined based on the theoretical spectra and the measured spectrum.

Specifically, the parameters involved in the spectrum computation model include the refractive index n₁ of the first layer, the refractive index n₂ of the wafer film, the refractive index n₃ of the wafer substrate, the refractive index n₄ of the second layer, and the thickness d₄ of the second layer, where n₁, n₂, and n₃ are known, and in this embodiment a plurality of n₄ are given, which are denoted as [n₄ᵢ, n₄ⱼ], and a plurality of d₄ are given, which are denoted as [d₄ᵢ, d₄ⱼ].

In this embodiment, the thickness d₂ of the wafer film is a known fixed value, and a plurality of theoretical spectra corresponding to [n₁ᵢ, n₁ⱼ] and [d₄ᵢ, d₄ⱼ] are computed based on the spectrum computation model.

The plurality of theoretical spectra may be matched with the measured spectrum, and a part of the theoretical spectra of which a matching degree is higher than the threshold is screened out, a corresponding refractive index is denoted as [n₁ⱼ, n₁ₖ], and a corresponding thickness is denoted as [d₄ⱼ, d₄ₖ]; and if a sufficiently high threshold is set, a theoretical spectrum matching the measured spectrum may also be obtained, a corresponding refractive index is denoted as nip, and a corresponding thickness is denoted as d 4p.

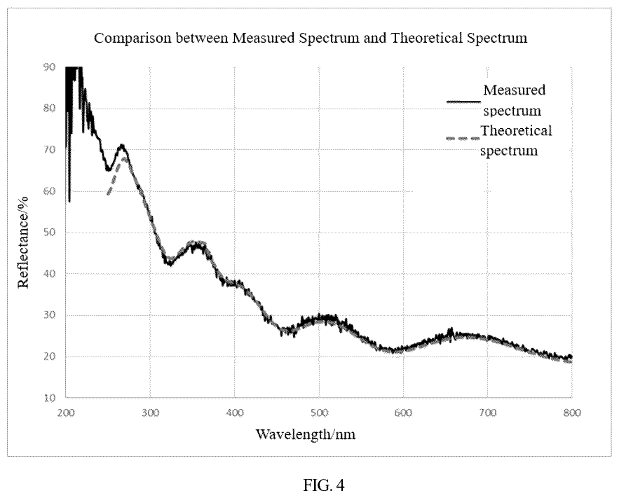

Therefore, a value may be respectively selected from [n₁ⱼ, n₁ₖ] and [d₄ⱼ, d₄ₖ] as a spectrum parameter of the second layer, or n₁ₚ and d₄ₚ may be used as spectrum parameters of the second layer. FIG. 4 shows a curve (dashed line) of a theoretical spectrum and a curve (solid line) of a measured spectrum. If it is considered that the similarity between the two curves is high enough, the thickness and the refractive index of the second layer of the theoretical spectrum can be determined as a determined result.

In this embodiment, the theoretical spectrum is generated based on the given spectrum parameter of the second layer, and a value of the spectrum parameter of the second layer is determined by matching with the measured spectrum, so that the accuracy is relatively high.

This embodiment further provides a method for measuring a film thickness in situ. Online detection is performed based on reference spectra (reference spectrum library) of different given thicknesses of the wafer film obtained by the above method. The method needs to be performed by an electronic device such as a computer or a server, and includes the following operation steps:

A measured spectrum is acquired during a grinding process of the wafer film.

The measured spectrum is matched with a reference spectrum library. One reference spectrum that is most similar to the measured spectrum is determined by comparing all the reference spectra with the measured spectrum one by one. There are a variety of methods for computing the similarity between two the spectra, and there are a variety of indexes for measuring the similarity or matching degree, for example, a similarity method, a nonlinear regression method, an FFT method, and the like.

A wafer film thickness corresponding to a reference spectrum matched with the measured spectrum is acquired as a real-time detection result.

This embodiment further provides an endpoint detection method for wafer film grinding. The grinding is controlled in real time based on the above online detection method. The method needs to be performed by an electronic device such as a computer or a server, and includes the following operation steps:

during a wafer grinding process, whether a thickness of a wafer film reaches a target thickness is monitored in real time based on the above method for measuring a film thickness in real time in situ; and when the thickness of the wafer film reaches the target thickness, the grinding is stopped.

Those skilled in the art will understand that the embodiments of the present invention may be provided as a method, a system, or a computer program product. Therefore, the present invention may be in the form of a hardware only embodiment, a software only embodiment, or an embodiment with a combination of software and hardware. Moreover, the present invention may be in the form of a computer program product that is implemented on one or more computer-usable storage media (including but not limited to a disk memory, a CD-ROM, an optical memory, and the like) that include computer-usable program code.

The present invention is described with reference to the flowcharts and/or block diagrams of the method, the device (system), and the computer program product according to the embodiments of the present invention. It should be understood that a computer program instruction may be used to implement each process and/or each block in the flowcharts and/or the block diagrams and a combination of a process and/or a block in the flowcharts and/or the block diagrams. These computer program instructions may be provided to a general-purpose computer, a special-purpose computer, an embedded processor, or a processor of another programmable data processing device to generate a machine, so that the instructions executed by a computer or a processor of any other programmable data processing device generate an apparatus for implementing a specified function in one or more processes in the flowcharts and/or in one or more blocks in the block diagrams.

These computer program instructions may also be stored in a computer readable memory that can instruct the computer or any other programmable data processing device to work in a specific manner, so that the instructions stored in the computer readable memory generate an artifact that includes an instruction apparatus. The instruction apparatus implements a specific function in one or more processes in the flowcharts and/or in one or more blocks in the block diagrams.

These computer program instructions may alternatively be loaded onto a computer or another programmable data processing device, so that a series of operations and steps are performed on the computer or the another programmable device, thereby generating computer-implemented processing. Therefore, the instructions executed on the computer or the another programmable device provide steps for implementing a specified function in one or more processes in the flowcharts and/or in one or more blocks in the block diagrams.

Apparently, the above embodiments are merely examples for clear description, but are not intended to limit the implementations. For a person of ordinary skill in the art, other changes or modifications in different forms may be made on the basis of the above description. All implementations need not be and cannot be exhaustive herein. Obvious changes or modifications derived therefrom are still within the protection scope of the present invention.

What is claimed is:

1. A reference spectrum generation method for measuring a film thickness in situ, comprising the following steps:
acquiring a spectrum computation model having parameters of a first layer and a second layer, wherein the second layer is located between the first layer and a wafer film;
determining spectrum parameters of the first layer, the second layer, the wafer film, and a wafer substrate; and
computing, based on the spectrum parameters and the spectrum computation model, reference spectra under different given thicknesses of the wafer film.

2. The method of claim 1, wherein the step of determining the spectrum parameter of the second layer comprises:
acquiring a measured spectrum of a surface of a wafer in a state of a first layer and a second layer, wherein the wafer comprises a wafer substrate and a wafer film, and parameters of the wafer substrate and the wafer film are known parameters measured in advance;
generating, based on the spectrum computation model, theoretical spectra under different given spectrum parameters of the second layer; and
determining the spectrum parameter of the second layer based on the theoretical spectra and the measured spectrum.

3. The method of claim 2, wherein the step of the determining the spectrum parameter of the second layer based on the theoretical spectra and the measured spectrum comprises:
matching a plurality of theoretical spectra with the measured spectrum, and screening out a theoretical spectrum of which a matching degree is higher than a threshold; and
determining the spectrum parameter of the second layer based on the theoretical spectrum of which the matching degree is higher than the threshold.

4. The method of claim 1, wherein the spectrum parameters comprise a refractive index n₁ of the first layer, a refractive index n₂ of the wafer film, a refractive index n₃ of the wafer substrate, a refractive index n₄ of the second layer, and a thickness d₄ of the second layer.

5. The method of claim 4, wherein the spectrum computation model comprises:
$$R = r \cdot {r}^{*}$$
wherein r is a total reflection coefficient determined based on n₁, n₂, n₃, n₄, and d₄, r* represents a conjugate complex number of r, and R is a reflectance.

6. The method of claim 5, wherein the total reflection coefficient r is computed in the following manner:
computing, based on n₁, n₂, n₃, and n₄, reflection coefficients of an interface of each layer;
computing, based on n₂, a wavelength λ, and a thickness d₂ of the wafer film, a phase thickness θ of the wafer film;
computing, based on n₄, the wavelength λ, and the thickness d₄, a phase thickness α of the second layer; and
computing, based on the reflection coefficients of an interface of each layer, the phase thickness α, and the phase thickness θ, the total reflection coefficient r.

7. The method of claim 6, wherein the reflection coefficients of an interface of each layer comprise a reflection coefficient r₂ of an interface between the wafer film and the wafer substrate, a reflection coefficient r₃ of an interface between the first layer and the second layer, and a reflection coefficient r₄ of an interface between the second layer and the wafer film.

8. The method of claim 7, wherein the step of computing the reflection coefficients of an interface of each layer comprises:
computing, based on n₂ and n₃, the reflection coefficient r₂ of the interface between the wafer film and the wafer substrate;
computing, based on n₁ and n₄, the reflection coefficient r₃ of the interface between the first layer and the second layer; and
computing, based on n₂ and n₄, the reflection coefficient r₄ of the interface between the second layer and the wafer film.

9. The method of claim 7, wherein the step of computing the total reflection coefficient r comprises:
computing, based on θ, r₂, and r₄, an equivalent interface reflection coefficient r_{equivalent}; and
computing, based on a, r₃, and r_{equivalent}, the total reflection coefficient r.

10. A reference spectrum generation method for measuring a film thickness in situ, comprising the following steps:
acquiring a spectrum computation model, wherein the spectrum computation model comprises parameters of a surface equivalent layer and a wafer, and the surface equivalent layer is at least used for simulating a layer formed by a substance between bulk phase water on a surface of a wafer film and the surface of the wafer film;
determining spectrum parameters of the surface equivalent layer, a wafer film, and a wafer substrate; and
computing, based on the spectrum parameters and the spectrum computation model, reference spectra under different given thicknesses of the wafer film.

11. The method of claim 10, wherein the step of determining the spectrum parameter of the surface equivalent layer comprises:
acquiring a measured spectrum of a surface of a wafer in a state of a surface equivalent layer, wherein the wafer comprises a wafer substrate and a wafer film, and parameters of the wafer substrate and the wafer film are known parameters measured in advance;
generating, based on the spectrum computation model, theoretical spectra under different given spectrum parameters of the surface equivalent layer; and
determining the spectrum parameter of the surface equivalent layer based on the theoretical spectra and the measured spectrum.

12. The method of claim 11, wherein the step of determining the spectrum parameter of the surface equivalent layer based on the theoretical spectra and the measured spectrum comprises:
matching a plurality of theoretical spectra with the measured spectrum, and screening out a theoretical spectrum of which a matching degree is higher than a threshold; and
determining the spectrum parameter of the surface equivalent layer based on the theoretical spectrum of which the matching degree is higher than the threshold.

13. The method of claim 10, wherein the spectrum parameters comprise a refractive index n₁ of the surface equivalent layer, a refractive index n₂ of the wafer film, and a refractive index n₃ of the wafer substrate.

14. The method of claim 13, wherein the spectrum computation model comprises:
$$R = r \cdot {r}^{*}$$
wherein r is a total reflection coefficient determined based on n₁, n₂, and n₃, r* represents a conjugate complex number of r, and R is a reflectance.

15. The method of claim 14, wherein the total reflection coefficient r is computed in the following manner:
computing, based on n₁, n₂, and n₃, reflection coefficients of an interface of each layer;
computing, based on n₂, a wavelength, and a thickness d₂, a phase thickness θ of the wafer film; and
computing, based on the reflection coefficients of an interface of each layer and the phase thickness θ, the total reflection coefficient r.

16. The method of claim 15, wherein the reflection coefficients of an interface of each layer comprise a reflection coefficient r₁ of an interface between the surface equivalent layer and the wafer film, and a reflection coefficient r₂ of an interface between the wafer film and the wafer substrate.

17. The method of claim 16, wherein the step of computing the reflection coefficients of an interface of each layer comprises:
computing, based on n₁ and n₂, the reflection coefficient r₁ of the interface between the surface equivalent layer and the wafer film; and
computing, based on n₂ and n₃, the reflection coefficient r₂ of the interface between the wafer film and the wafer substrate.

18. The method of claim 10, wherein the surface equivalent layer is further used for simulating the bulk phase water on the surface of the wafer film, and a layer formed by a variety of dielectrics between the bulk phase water and a spectrum collection end.

19. The method of claim 1, wherein the reference spectrum comprises a curve of a correspondence between of a wavelength and a reflectance.

20. A method for measuring a film thickness in situ, comprising the following steps:
acquiring a measured spectrum during a grinding process of the wafer film;
matching the measured spectrum with a reference spectrum library obtained based on the method of claim 1; and
acquiring a wafer film thickness corresponding to a reference spectrum matched with the measured spectrum as a real-time detection result.

21. An endpoint detection method for wafer film grinding, comprising the following steps:
monitoring, based on the method for measuring a film thickness in situ of claim 20, whether a thickness of a wafer film reaches a target thickness in real time; and
stopping grinding when the thickness of the wafer film reaches the target thickness.

22. An electronic device, comprising: a processor and a memory connected to the processor, wherein the memory stores instructions that can be executed by the processor, and the instructions are executed by the processor, so that the processor performs the method of claim 1.

23. A chemical mechanical polish device, used for performing chemical mechanical polish on a wafer film, and measuring a thickness of the wafer film based on the method of claim 20.
